(19) United States
(12) Patent Application Publication
(10) Pub. No.: US 2001/0016483 A1
(43) Pub. Date: Aug. 23, 2001

(54) Ringing tone data delivery system and method thereof

(75) Inventor: Toshikazu Nakajima, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/789,412

(22) Filed: Feb. 20, 2001

(30) Foreign Application Priority Data
Feb. 23, 2000 (JP) 045295/2000

(51) Int. Cl. H04M 11/00

(52) U.S. Cl. 455/406; 455/412; 455/414; 455/517; 455/566

(57) ABSTRACT

A ringing tone data delivery system and a method used this system, in which at least a part of communication charge is not paid by a user of a cellular phone at the time when the cellular phone downloads ringing tone data from the outside, are provided. When a cellular phone sets a ringing tone, the cellular phone accesses to a database via a base station and a control station in a telecommunication network, and obtains ringing tone data. The database mainly stores the ringing tone data, and the ringing tone data are stored in the database in two types, that is, one is “only ringing tone data”, and the other is “ringing tone data+advertisement data”. The cellular phone downloads the ringing tone data from the database via the control station and the base station in the telecommunication network, and stores the ringing tone data in a memory through an antenna, a radio section, and a controller provided in the cellular phone. At the case that ringing tone data being “ringing tone data+advertisement data” are downloaded, the advertisement data are displayed on a display and/or outputted from a speaker in the cellular phone at the time while the cellular phone is downloading the ringing tone data or after the cellular phone finished downloading the ringing tone data. In this case, at least a part of communication charge at the time of downloading is paid by the side who sponsored the advertisement data.

### BACKGROUND OF THE INVENTION

The present invention relates to a ringing tone data delivery system and method thereof, in particular, to cellular phones.

### Description of the Related Art

At a cellular phone, when a telephone call arrives from a sender, a ringing tone such as a music melody is reproduced, and the user notices the arrival of the telephone call. This ringing tone is delivered from a supplier via a telecommunication network, or is made by the user by touching the keyboard of the cellular phone, and is stored in a memory in the cellular phone.

However, the capacity of the memory in the cellular phone is limited to a designated value, consequently it is impossible that every user has his/her own desirable ringing tone in its cellular phone. In order to solve this, Japanese Patent Application Laid-Open No. HEI 10-4442 discloses a cellular phone and a cellular phone system. In this application, audio data using as its ringing tone are compressed and the compressed data are stored in the memory.

At this cellular phone, when a user desires to change the ringing tone, the user sets the ringing tone by him/her own operation or makes the ringing tone data deliver from a database of an outside supplier. However, when the user downloads the ringing tone data from the outside supplier, there is a problem that the user must pay its communication charge.

### SUMMARY OF THE INVENTION

It is therefore an object of the present invention to provide a ringing tone data delivery system and a ringing tone data delivery method used this system, by which a user can save the communication charge at the time when the user downloads ringing tone data to his/her cellular phone.

According to the present invention, there is provided a ringing tone data delivery system, which delivers ringing tone data from the outside to a cellular phone that reproduces a ringing tone stored in a memory in its inside when the cellular phone received a telephone call from a sender. And the ringing tone delivery system provides a database, in which ringing tone data and ringing tone data attached advertisement information are stored. And at least a part of communication charge is paid by the side who sponsored the advertisement information, at the time when the cellular phone downloads one of the ringing tone data attached the advertisement information.

According to the present invention, there is provided a ringing tone data delivery method, which delivers ringing tone data from the outside to a cellular phone that reproduces a ringing tone stored in a memory in its inside when the cellular phone received a telephone call from a sender. The ringing tone data delivery method provides the step of storing ringing tone data and ringing tone data attached advertisement information in a database. And at least a part of communication charge is paid by the side who sponsored the advertisement information, at the time when the cellular phone downloads one of the ringing tone data attached the advertisement information.

According to the present invention, at the ringing tone data delivery system, a cellular phone having a data communication function is connected to an outside database via a base station, in which ringing tone data attached advertisement information are stored. And when a user downloads desirable ringing tone data attached the advertisement information, the advertisement information attached to the desirable ringing tone data is displayed on a display in the cellular phone and/or outputted from a speaker of the cellular phone. The ringing tone data and the advertisement information are supplied by sponsors, and the ringing tone itself and the advertisement information can be used as the advertisement, during and after the download of the ringing tone data attached the advertisement information. At this time, the sponsors pay at least a part of the communication charge during the downloading, therefore the user can obtain the ringing tone data with a fewer communication charge.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a structure of an embodiment of a ringing tone data delivery system of the present invention;

FIG. 2 is a flowchart showing operation at the time when a controller in a cellular phone obtains ringing tone data; and

FIG. 3 is a flowchart showing another operation at the time when the controller in the cellular phone obtains the ringing tone data.

### DESCRIPTION OF THE PREFERRED EMBODIMENTS

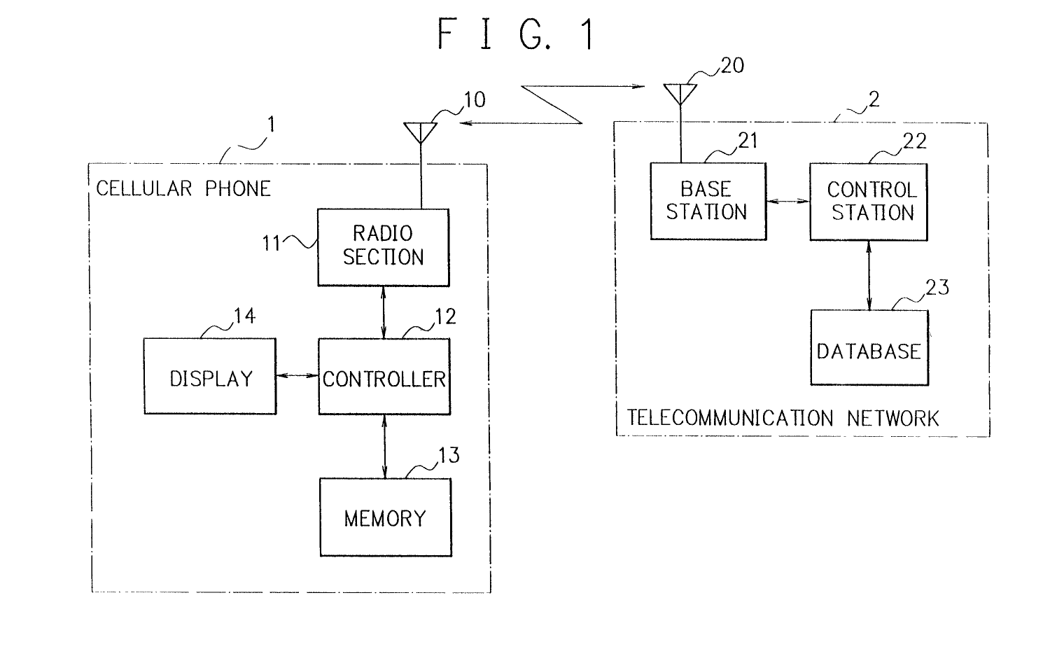

Referring now to the drawings, embodiments of the present invention are explained in detail. FIG. 1 is a block diagram showing a structure of an embodiment of a ringing tone data delivery system of the present invention. As shown in FIG. 1, the embodiment of the ringing tone data delivery system of the present invention consists of a cellular phone 1 and a telecommunication network 2, and the cellular phone 1 and the telecommunication network 2 communicate with each other by radio. In this, actually, plural cellular phones 1 can be connected to this telecommunication network 2, however, in order to make this explanation concise, one cellular phone is used for this explanation.

The cellular phone 1 provides an antenna 10, a radio section 11, a controller 12, a memory 13, a display 14, and a speaker (not shown). The telecommunication network 2 provides a base station 21, a control station 22, and a database 23, and the base station 21 provides an antenna 20.

The cellular phone 1 has a data communication function for accessing to the database 23 via the base station 21 and the control station 22 and for obtaining ringing tone data, at the case that the cellular phone 1 sets its ringing tone.

In the database 23, the ringing tone data are mainly stored and are stored in two types, one is “only ringing tone data”, and the other is “ringing tone data+advertisement data”.

The ringing tone data, which the cellular phone 1 downloaded from the database 23 via the base station 21 and the control station 22, are stored in the memory 13 through the antenna 10, the radio section 11, and the controller 12. At the case that the “ringing tone data+ advertisement data” are downloaded, its advertisement data part is displayed on the display 14 and/or is outputted from the speaker (not shown), at the time while the ringing tone data are downloading or after finished this download.

When a user decided to change its ringing tone by using the outside database, the cellular phone 1 communicates with the database 23 via the base station 21 and the control station 22, and obtains the newest plural menus from the database 23 and displays the newest plural menus on the display 14.

When the user selects one of the newest plural menus displayed on the display 14, which the user wants to obtain, the controller 12 in the cellular phone 1 downloads the ringing tone data from the database 23 and stores the downloaded ringing tone data in the memory 13. With this, the user can use the ringing tone data as his/her ringing tone.

Some of the ringing tone data stored in the database 23 are registered as the type “ringing tone data+advertisement data” by sponsors. And the sponsors pay a part or all of the communication charge at the time when the user downloads the ringing tone data, therefore this gives an incentive to the user.

In this case, during the downloading the ringing tone data or after the ringing tone data were downloaded, the advertisement data attached to the main part of the ringing tone data are displayed on the display 14 and /or outputted from the speaker as an advertisement. At this time, the advertisement data can be always displayed at the margin of the display 14.

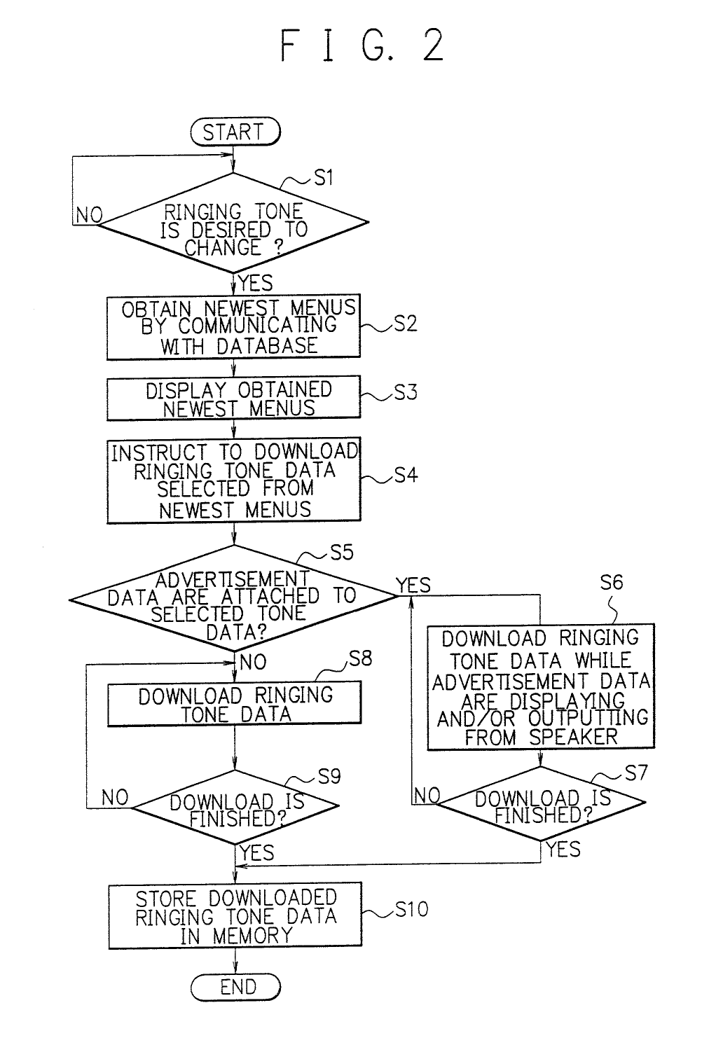

FIG. 2 is a flowchart showing operation at the time when the controller 12 in the cellular phone 1 obtains ringing tone data. Referring to FIGS. 1 and 2, the operation of processes obtaining the ringing tone data at the embodiment of the present invention is explained. In this explanation, the step number showing in parentheses is the step number in FIG. 2.

First, when a user decided to change a ringing tone (step S1), the cellular phone 1 communicates with the database 23 via the base station 21 and the control station 22, and obtains plural newest menus from the database 23 (step S2) and displays the obtained plural newest menus on the display 14 (step S3).

When the user selects desirable ringing tone data from the plural newest menus displayed on the display 14, the controller 12 in the cellular phone 1 instructs the control station 22 to download the desirable ringing tone data from the database 23 via the base station 21 (step S4).

The controller 12 judges whether advertisement data are attached to the selected ringing tone data to be downloaded from the database 23 or not (step S5). At the case that the advertisement data are not attached (NO at the step S5), the controller 12 downloads the ringing tone data from the database 23 (step S8), and after finished the download (YES at step S9), the ringing tone data are stored in the memory 13 (step S10). And the ringing tone data becomes to be used at the cellular phone 1.

At the case that the advertisement data are attached (YES at the step S5), the controller 12 downloads the ringing tone data from the database 23 while the advertisement data are displaying on the display 14 and/or outputting from the speaker (step S6). And after finished the download (YES at step S7), the ringing tone data are stored in the memory 13 (the step S10). And the ringing tone data becomes to be used at the cellular phone 1. In this case, when the ringing tone data are downloaded to the controller 12, the sponsor registered the attached advertisement data pays a part or all of the communication charge, therefore the user can obtain the ringing tone data with a fewer charge.

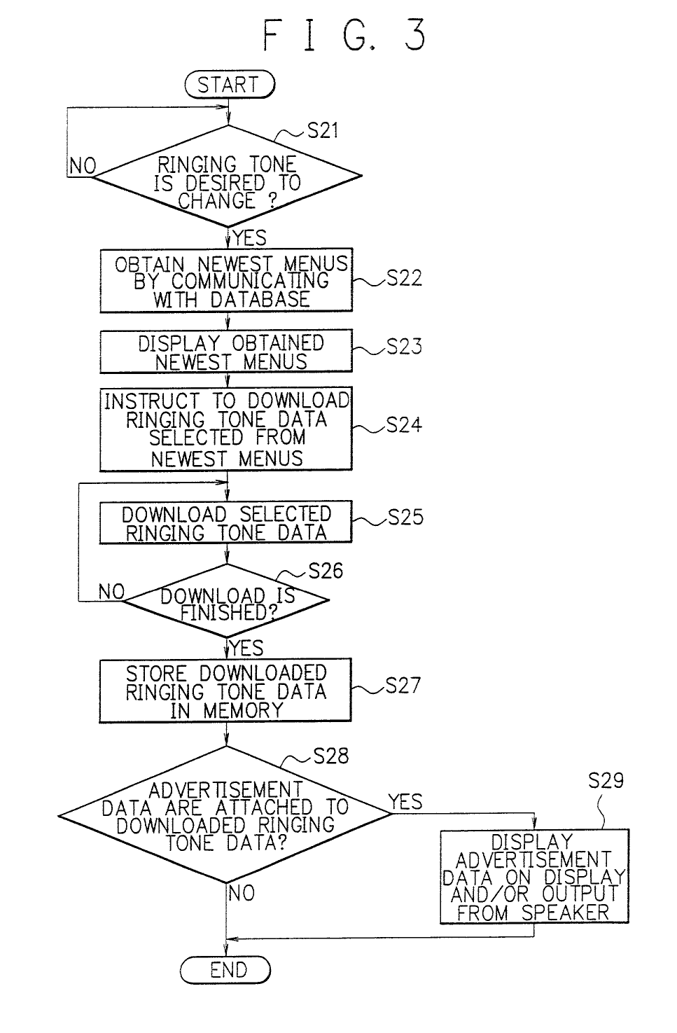

FIG. 3 is a flowchart showing another operation at the time when the controller 12 in the cellular phone 1 obtains the ringing tone data. Referring to FIGS. 1 and 3, another operation of processes obtaining the ringing tone data at the embodiment of the present invention is explained. In this explanation, the step number showing in parentheses is the step number in FIG. 3.

First, when a user decided to change a ringing tone (step S21), the cellular phone 1 communicates with the database 23 via the base station 21 and the control station 22, and obtains plural newest menus from the database 23 (step S22) and displays the obtained plural newest menus on the display 14 (step S23).

When the user selects desirable ringing tone data from the plural newest menus displayed on the display 14, the controller 12 in the cellular phone 1 instructs the control station 22 to download the desirable ringing tone data from the database 23 via the base station 21 (step S24).

The controller 12 in the cellular phone 1 downloads the selected ringing tone data from the database 23 (step S25), after finished the download (YES at step S26), the downloaded ringing tone data are stored in the memory 13 (step S27). And the ringing tone data becomes to be used at the cellular phone 1.

After this, the controller 12 judges whether the advertisement data are attached to the ringing tone data downloaded from the database 23 or not (step S28). At the case that the advertisement data are attached (YES at the step S28), the controller 12 makes the display 14 display the advertisement data for a designated time or display the advertisement data always, and/or makes the speaker output the ringing tone data (step S29).

In this case, when the ringing tone data are downloaded to the controller 12, the sponsor registered the attached advertisement data pays a part or all of the communication charge, therefore the user can obtain the ringing tone data with a fewer charge.

With this, an effect to make an advertisement recognize to the user by displaying the advertisement data, and an effect to promote contents of the advertisement to the user by using the ringing tone as a BGM (back ground music) are obtained by utilizing the widely spread size, portability, and immediate communication of cellular phones. And further, an effect, which a communication charge for the user can be reduced, is obtained.

As mentioned above, according to the present invention, at a ringing tone data delivery system, which delivers ringing tone data from outside to a cellular phone, which reproduces the ringing tone data stored in a memory provided inside of the cellular phone when the cellular phone receives a telephone call from a sender, advertisement information is attached to the ringing tone data. With this, by providing an outside database, in which data that bear at least a part of a communication charge when the data are downloaded to a cellular phone are stored, the communication charge for the user at the time when the user downloads the ringing tone data to the cellular phone can be reduced.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A ringing tone data delivery system, which delivers ringing tone data from the outside to a cellular phone that reproduces a ringing tone stored in a memory in its inside when said cellular phone received a telephone call from a sender, comprising:
a database, in which ringing tone data and ringing tone data attached advertisement information are stored, wherein:
at least a part of communication charge is paid by the side who sponsored said advertisement information, at the time when said cellular phone downloads one of said ringing tone data attached said advertisement information.

2. A ringing tone data delivery system in accordance with claim 1, wherein:
said cellular phone displays on a display and/or outputs from a speaker said advertisement information attached to said ringing tone data while said cellular phone is downloading said ringing tone data attached said advertisement information from said database.

3. A ringing tone data delivery system in accordance with claim 1, wherein:
said cellular phone displays on a display and/or outputs from a speaker said advertisement information attached to said ringing tone data after said cellular phone finished downloading said ringing tone data attached said advertisement information from said database.

4. A ringing tone data delivery system in accordance with claim 1, wherein:
said cellular phone displays on a display and/or outputs from a speaker said advertisement information attached to said ringing tone data for a predetermined time after said cellular phone finished downloading said ringing tone data attached said advertisement information from said database.

5. A ringing tone data delivery system in accordance with claim 1, wherein:
said cellular phone always displays said advertisement information attached to said ringing tone data after said cellular phone finished downloading said ringing tone data attached said advertisement information from said database.

6. A ringing tone data delivery method, which delivers ringing tone data from the outside to a cellular phone that reproduces a ringing tone stored in a memory in its inside when said cellular phone received a telephone call from a sender, comprising the step of:
storing ringing tone data and ringing tone data attached advertisement information in a database, wherein:
at least a part of communication charge is paid by the side who sponsored said advertisement information, at the time when said cellular phone downloads one of said ringing tone data attached said advertisement information.

7. A ringing tone data delivery method in accordance with claim 6, wherein:
said cellular phone displays on a display and/or outputs from a speaker said advertisement information attached to said ringing tone data while said cellular phone is downloading said ringing tone data attached said advertisement information from said database.

8. A ringing tone data delivery method in accordance with claim 6, wherein:
said cellular phone displays on a display and/or outputs from a speaker said advertisement information attached to said ringing tone data after said cellular phone finished downloading said ringing tone data attached said advertisement information from said database.

9. A ringing tone data delivery method in accordance with claim 6, wherein:
said cellular phone displays on a display and/or outputs from a speaker said advertisement information attached to said ringing tone data for a predetermined time after said cellular phone finished downloading said ringing tone data attached said advertisement information from said database.

10. A ringing tone data delivery method in accordance with claim 6, wherein:
said cellular phone always displays said advertisement information attached to said ringing tone data after said cellular phone finished downloading said ringing tone data attached said advertisement information from said database.
